(19) United States
(12) Patent Application Publication
(10) Pub. No.: US 2010/0233651 A1
(43) Pub. Date: Sep. 16, 2010

(54) Electric Motor For Use in a Dentist's, Dental Surgeon's or Dental Technician's Hand Piece

(75) Inventors: Bernhard Kuhn, Biberach (DE); Alexander Klee, Biberach (DE); Alfons Mader, Isny (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: KALTENBACH & VOIGHT GMBH, Biberach (DE)

(21) Appl. No.: 12/682,200

(22) PCT Filed: Oct. 8, 2008
(86) PCT No.: PCT/EP08/08484

§ 371 Date: Apr. 8, 2010

(30) Foreign Application Priority Data
Oct. 9, 2007 (DE) 10 2007 048 340.8

(51) Int. Cl. A61C 1/06; H02K 5/16

(52) U.S. Cl. 433/131; 310/90

(57) ABSTRACT

In an electric motor for use in a handpiece for dentistry, dental medicine or dental technology, with a rotor held rotatably by a bearing arrangement, and a stator surrounding the rotor, a bearing arrangement has a first bearing located on an end region of the rotor, and a second bearing located on an opposite end region of the rotor, which second bearing is constructed as a movable bearing and is biased in the direction of the first bearing by a spring arrangement. The spring force of the spring arrangement within an operating region is substantially independent of the position of the movable bearing.

The present invention relates to an electric motor according to the preamble of claim 1, provided for use in a handpiece for dentistry, dental medicine or dental technology. The present invention relates in particular to a so-called collectorless motor.

In handpieces for dentistry, dental medicine or dental technology treatment or processing instruments are set in rotation or vibrations with the aid of a drive. The drive may on the one hand be designed in the form of an air turbine or an air motor, though, alternatively to this, recently the use of electric motors has also increasingly gained ground. Used in particular in this case are so-called collectorless or brushless direct current motors (BLDC motors), whose rotor has at least one permanent magnet. Motors of this kind are distinguished by their high efficiency and the option of being able to vary the speed and torque.

A collectorless motor of this kind normally has a bearing integrated in the stator for the rotor of the motor. One bearing is in this case usually designed as a so-called movable bearing and the second bearing as a fixed bearing. In order to guarantee smooth running and therefore also a long serviceable life of the rotor bearings, they must be adjusted in each operating state at a specific, preset force, which is as constant as possible. It is correspondingly known from the prior art to bias radial ball bearings in the direction of the fixed bearing by so-called corrugated washers.

Because of the insulating effect and also on grounds of hygiene, the stator housing of an electric motor usually consists of plastics material which has a greater thermal expansion than steel. If during operation of the motor heating thereof occurs, the result of this is that the stator expands. The distance between the two bearings for the rotor increases in this case, i.e. the fixed bearing migrates with the stator and thus changes the position of the rotor. The spring adjustment of the movable bearing therefore at least decreases in force or even transfers into a state in which the axis of the rotor is no longer adjusted in the desired way. The corrugated washer known from the prior art for adjusting the movable bearing in these circumstances entails the disadvantage that the force increases relatively steeply looked at over the actuation path. If a specific operating point has been established during production of the motor, the force fluctuates relatively sharply during operation of the motor as a result of even a small stroke. Since additionally a displacement of the operating point on the spring core line may further result from tolerances of the stator and the axis caused by manufacture, the adjusting force for the movable bearing, created by the corrugated washer, is subject to relatively strong fluctuations.

The object of the present invention is accordingly to avoid the disadvantages known from the prior art, in order to achieve reliable spring adjustment for the movable bearing of the electric motor.

The object is achieved by an electric motor which has the features of claim 1. Advantageous further developments of the invention are the subject matter of the dependent claims.

The solution according to the invention is based on the idea of using, to adjust the movable bearing, a spring arrangement, which is designed in such a way that the force it exerts within a preset operating region is substantially independent of the position of the movable bearing.

According to the present invention an electric motor for use in a handpiece for dentistry, dental medicine or dental technology is accordingly proposed, which has a rotor held rotatably by means of a bearing arrangement and a stator surrounding the rotor, wherein the bearing arrangement has on the one hand a first bearing, located on an end region of the rotor—preferably in the form of a fixed bearing—and on the other hand a second bearing, located on the opposite region of the rotor, constructed as a movable bearing and biased in the direction of the first bearing by means of a spring arrangement, and wherein according to the invention it is provided that the spring force of the spring arrangement within an operating region is substantially independent of the position of the movable bearing.

Because of the independence, according to the invention, of the spring force of the spring arrangement used, the advantage arises that the movable bearing is in principle adjusted in every situation in a constant way in respect of the first or fixed bearing. This leads, beyond the operation of the electric motor, to considerably better properties, which ultimately also lead to a longer service life of the motor overall.

At the same time according to a preferred embodiment it can in particular be provided that the spring arrangement is formed by a parallel arrangement of several compression springs which are effective in the axial direction of the electric motor. In this case there is a possibility of easily having an influence on the characteristic curve of the springs via, e.g., the thickness of the wire or the number of windings of the individual springs, in other words for example to configure them with a relatively flat characteristic curve. This parallel arrangement of several, in particular three, compression springs, moreover allows parallel displacement of the characteristic curve towards different forces, without having to change the spring constant. The force at the operating point also accordingly varies considerably less at different positions of the rotor caused by tolerances than would be the case with a corrugated washer. A further advantageous effect is also the smaller change in force when there is a stroke around the operating point, if a thermally caused deformation of the electric motor occurs.

The compression springs are in particular arranged evenly spaced over the circumference of the movable bearing. They may be formed by helical springs, a contact face for the individual compression springs being formed by an outer ring of the movable bearing. Accommodation of the individual springs preferably takes place inside a specific bearing bushing, which also prevents the springs from falling out in the demounted state of the rotor.

Finally, by the solution according to the invention it is achieved that the operating conditions of the motor are further improved compared with solutions known from the prior art.

The invention will be explained in greater detail below using the attached drawings.

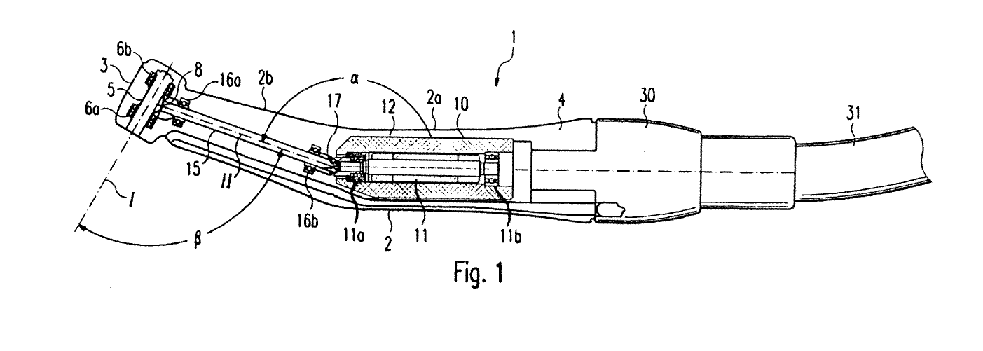

FIG. 1 shows the illustration of a dental handpiece for which the use of an electric motor according to the invention is planned,

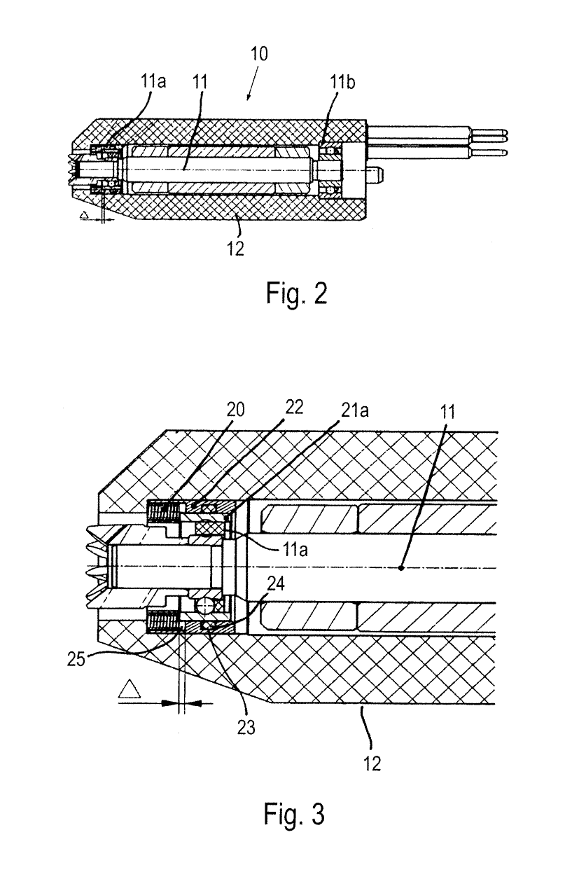

FIG. 2 shows the sectional illustration of the electric motor according to the invention, and

FIG. 3 shows an enlarged illustration of the front end region of the motor with the movable bearing.

The handpiece schematically illustrated in FIG. 1 and generally provided with the reference numeral 1, in which the electric motor according to the invention is used has an elongated handle casing 2, which is divided into a rear region 2a and a front region 2b, wherein the two regions 2a, 2b enclose an angle α of approximately 155° to 170° with one another. Handling the handpiece 1 inside a patient's oral cavity is simplified by this angled design. At this point it should, though, be pointed out that the use of the electric motor according to the invention, described in greater detail below, is not confined to such so-called angled handpieces. Instead, the motor can be used generally in handpieces for dentistry, dental medicine or dental technology.

At the front end of the handle casing is the head region of the handpiece 1, which has a tool holder 5, held rotatably by means of two bearings 6a, 6b. This tool holder is provided in particular to accommodate dental drills. For ergonomic reasons it may be further provided that the head region 3 is designed in such a way that the longitudinal axis I of the tool holder 5 encloses with the axis II of the front end region 2b of the handle casing an angle β of approximately 100°. The tool holder 5 is in this case set into rotation with the aid of the motor 10, described in greater detail below, the revolving of the motor 10 being transferred via a drive shaft 15 extending through the front handle casing region 2b. The drive shaft 15 is in this case held rotatably by means of two bearings 16a, 16b and at its rear end coupled via a transmission 17 to the rotor 11 of the motor 10 and at its front end via a further transmission 8 to the tool holder 5.

At the rear end of the handle casing 2 it is connected to the connecting part 30 of a supply tube 31. This tube 31 leads to a supply device (not shown) of a dental treatment centre and serves to make available to the handpiece 1 the media needed for operation. This is in particular electricity used for operating the motor. Also additional treatment media such as air and/or water can be conducted to the handpiece 1 via the tube 31. Connection of the handpiece 1 is then done via a coupling element 4, located in the rear end, via which a connection to the tube connection 30 is made.

Dental handpieces can basically be designed with different drives. Classically air or turbine drives or electric drives are used, for example. A turbine is here distinguished by its compact design, but on the other hand operational safety is lower compared with an electric motor. There are also only limited possibilities for controlling the power to be transmitted, compared with an electric motor.

FIGS. 2 and 3 now show respectively the motor 10 according to the invention used in the handpiece 1, on its own, and the adjustment of the front movable bearing 11a in detail. The motor 10 has on the one hand a stator 12 which is held in a fixed manner—i.e. not rotatably—in the handpiece casing 2 and on the other hand a rotor 11, held rotatably in respect of this stator 12 with the aid of two ball bearings 11a and 11b. The rear bearing 11b is here designed as a fixed bearing whereas on the other hand the front bearing 11a—as already mentioned—forms a movable bearing.

Recognisable in the sectional illustration are two compression springs 20 which press on the outer ring 21a of the front ball bearing 11a. Preferably at least three such compression springs 20 are used, arranged evenly spaced over the circumference of the outer ring 21a of the movable bearing 11a, in order to guarantee that the ball bearing outer ring 21a is always positioned in a defined manner parallel to the contact face. The number of compression springs 20 used can also be increased, however, the maximum number being limited only by the available construction space.

The springs 20 are held in position with the aid of a component 22 in the form of a casing, designated below as a bearing bushing. The bearing bushing 22 rests against the outside of the outer ring 21a of the movable bearing 11a and has a groove 23 facing the outer ring 21a, in which an O-ring 24 is arranged for sealing. Further constructed in the front region of the bearing bushing 22 are appropriate recesses 25 to accommodate the compression springs 20, wherein these recesses 25 according to the illustration allow the springs 20 a stroke A and simultaneously prevent the springs 20 from falling out of the stator 12 when the rotor is demounted.

The axial fixing of the rear fixed bearing 11a is done via a corrugated spring assembly, not illustrated in greater detail, which ensures that bearing 11b rests against an appropriate stop 29, constructed in the rear end region of the stator 12, in every operating state.

Because of the parallel arrangement of the individual compression springs 20, it is achieved, as already mentioned that the force exerted by this spring arrangement on the outer ring 21a of the movable bearing 11a is substantially independent of the position of the movable bearing 11a. A further advantage of the solution according to the invention is that by appropriate selection of the thickness of the wire and the number of windings for the individual springs 20 it is easy to have an influence on the characteristic curve on the one hand of the individual springs and therefore on the other hand also of the entire spring arrangement. This allows, as desired, a spring arrangement with a relatively flat characteristic curve to be achieved, the force of which is therefore independent of the position of the movable bearing. Different positions of the rotor, caused by tolerances, which can be traced to effects of the manufacturing technology, can in this way easily be compensated for.

Finally, in this way adjustment of the rotor in the motor according to the invention is optimized, so that overall its operating properties and therefore its serviceable life can be considerably lengthened.

1. Electric motor for use in a handpiece for dentistry, dental medicine or dental technology, comprising:
a rotor,
a stator surrounding the rotor;
a plurality of bearings rotatably holding the motor, wherein the plurality of bearings includes a first bearing located on an end region of the rotor and a second bearing located on the opposite end region of the rotor, the second bearing including a movable bearing; and
a plurality of springs biasing the second bearing in the direction of the first bearing, wherein the biasing of the springs is substantially independent of the position of the movable bearing within an operating region.

2. Electric motor according to claim 1, wherein the plurality of springs include a parallel arrangement of a plurality of compression springs, the plurality of compression springs effective in the axial direction of the electric motor.

3. Electric motor according to claim 2, wherein the plurality of springs includes at least three compression springs.

4. Electric motor according to claim 2, wherein the compression springs are arranged evenly spaced over a circumference of the movable bearing.

5. Electric motor according to claim 4, wherein the compression springs are helical springs.

6. Electric motor according to claim 2, wherein a contact face for the compression springs is formed by an outer ring of the movable bearing.

7. Electric motor according to claim 2, wherein the compression springs are arranged inside a bearing bushing.

8. Electric motor according to claim 1, wherein the motor is a collectorless motor.

9. Electric motor according to claim 1, wherein the first bearing includes a fixed bearing.

10. Handpiece for dentistry, dental medicine or dental technology, comprising:
a tool rotatably held by the handpiece; and
a drive unit for driving the tool, wherein the drive unit includes an electric motor, the electric motor including:
a rotor;
a stator surrounding the rotor;
a plurality of bearings rotatably holding the motor, wherein the plurality of bearings includes a first bearing located on an end region of the rotor and a second bearing located on an opposite end region of the rotor, the second bearing including a movable bearing; and
a plurality of springs biasing the second bearing in the direction of the first bearing, wherein the biasing of the springs is substantially independent of the position of the movable bearing within an operating region.

11. Handpiece according to claim 10, wherein the plurality of springs include a parallel arrangement of a plurality of compression springs, the plurality of compression springs being effective in an axial direction of the electric motor.

12. Handpiece according to claim 11, wherein the plurality of springs includes at least three compression springs.

13. Handpiece according to claim 12, wherein the compression springs are arranged evenly spaced over a circumference of the movable bearing.

14. Handpiece according to claim 13, wherein the compression springs are helical springs.

15. Handpiece according to claim 14, wherein a contact face for the compression springs is formed by an outer ring of the movable bearing.

16. Handpiece according to claim 15, wherein the compression springs are arranged inside a bearing bushing.

17. Handpiece according to claim 1, wherein the motor is a collectorless motor.

18. Handpiece according to claim 1, wherein the first bearing includes a fixed bearing.
